(19) United States
(12) Patent Application Publication
(10) Pub. No.: US 2010/0154722 A1
(43) Pub. Date: Jun. 24, 2010

(54) SYSTEM FOR AND METHOD OF MANAGING A GROUP OF ANIMALS

(75) Inventors: Karel Van Den Berg, Bleskensgraaf (NL); Lucien Eliza Niels Voogd, Leerdam (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: MAASLAND N.V., MAASSLUIS (NL)

(21) Appl. No.: 12/713,228

(22) Filed: Feb. 26, 2010

Related U.S. Application Data
(63) Continuation of application No. PCT/EP2008/000149, filed on Jun. 13, 2008.

(30) Foreign Application Priority Data
Aug. 27, 2007 (NL) 1034292

(51) Int. Cl. A01K 15/04

(52) U.S. Cl. 119/720

(57) ABSTRACT

A system for and method of managing a group of animals include a control system, a camera operatively connected to it for forming a depth-image of at least one animal, and an animal management or actuator mechanism operatively connected to the control system. The control system compares information regarding the depth-image formed by the camera with reference information regarding the animal, generates control information on this basis, and sends the control information to the animal management or actuator mechanism. The camera includes an emitting source of electromagnetic radiation, a matrix with a plurality of rows and columns of receivers for receiving radiation reflected from the animal, a lens for displaying the reflected radiation on the receivers, and a sensor controller operatively connected to the source of radiation in order to modulate the radiation and determine for each of the receivers a phase difference between the emitted and the reflected radiation.

### CROSS REFERENCE TO RELATED APPLICATIONS

This application is a continuation of international application number PCT/NL2008/000149 and claims priority from Netherlands application number 1034292 filed on Aug. 27, 2007, the contents of which are hereby incorporated by reference in their entirety.

### BACKGROUND OF THE INVENTION

1. Field of the Invention

The invention relates to a system for managing a group of animals, and particularly relates to a method and system for managing diary animals using a control system, a camera, a sensor controller and a animal management or actuator mechanism.

2. Description of the Related Art

EP-A-1,537,531 discloses a system for and a method of determining the physical condition of an animal. For this purpose, a matrix of rays of light is emitted to a part to be analysed of the animal, which results in a pattern of light points on the part to be analysed. This pattern is observed by a camera with an observation axis which is at an angle to the rays of light. In the case of a curved surface on the part to be analysed, the camera will observe that light points have shifted relative to a theoretic position which they would assume on a flat surface. On the basis of this shifting a spatial shape of the part to be analysed is calculated. This spatial shape is compared with a stored image of a shape, in order to determine the physical condition of the animal in question.

A drawback of the known system and the known method is that they do not always provide sufficiently reliable results.

### BRIEF SUMMARY OF THE INVENTION

The present invention addresses these problems by providing a system and a method which are more reliable than those of the state of the art.

This object is achieved by the invention by means of a system that is arranged to manage a group of animals, in particular dairy animals such as cows, and comprises: a control system, a camera, which is operatively connected to the control system for forming a depth-image of at least one of the animals, and an animal management or actuator mechanism which is operatively connected to the control system.

The control system is arranged to compare information regarding the depth-image observed by the camera with reference information regarding the animal, to generate control information on the basis of this comparison, and to send the control information to the animal management or actuator mechanism. The camera comprises: a source of radiation for emitting electromagnetic radiation, in particular light, a matrix with a plurality of rows and a plurality of columns of receivers for receiving electromagnetic radiation reflected from the dairy animal, a lens for displaying the reflected electromagnetic radiation on the receivers, and a sensor controller.

The sensor controller is operatively connected to the source of radiation in order to modulate the electromagnetic radiation, and is arranged to determine for each of the receivers a phase difference between the emitted and the reflected electromagnetic radiation.

A system with such sensor controller produces a reliable depth-image, in the form of distance or depth information, of a plurality of points on an object to be observed to the camera. Owing to the fact that the invention operates with modulated radiation, the camera is able to observe under the same angle as that at which the electromagnetic radiation is emitted. If, for example, a tail is swinging between the camera and a rear side to be observed of a cow, in the state of the art an interference of the light pattern on the rear side of the cow will occur. Owing to the fact that the tail blocks a part of the light, the number of light points displayed on the cow will be smaller than the number of light points emitted. This means that the state-of-the-art control is no longer able to deduce which displayed point belongs to which matrix point, so that it is no longer possible to compose a reliable image. In the system according to the invention, such a situation at the place of the tail results in smaller observed distances which make clear that something is partially situated between the camera and the cow, but apart from that the image of the part to be observed of the cow is unperturbed.

The following is an explanation of the operation of a possible camera. The source of radiation emits electromagnetic radiation. Preferably light is used for this purpose, more preferably infrared radiation, more preferably near-infrared (NIR) radiation. The fact is that, for this purpose, suitable LEDs can be used which are very easy to drive by implementation of an electrically controllable supply current, and which are, in addition, very compact and efficient and have a long service life. However, it would also be possible to use other sources of radiation. The advantage of (near-)infrared radiation is that the radiation does not irritate (dairy) animals.

The radiation is modulated, for example amplitude modulated, according to a modulation frequency which, of course, differs from, and is much lower than, the frequency of the electromagnetic radiation itself. The, for example, infrared light is in this case a carrier for the modulation signal.

By means of the emitted radiation, the distance is determined by measuring a phase shift of the modulation signal, by comparing the phase of reflected radiation with the phase of reference radiation. For the latter, the emitted radiation is preferably (almost) directly passed on to the receiver. The distance can easily be determined from the measured phase difference by applying

Distance=½×wavelength×(phase difference/2π),

wherein the wavelength is that of the modulation signal. Note that the above relation does not make any allowance yet for unique determination of the distance which results from the fact that a phase difference, due to the periodicity, may be associated with a distance A, but also with A+n×(wavelength/2). For this reason, it may be sensible to select the wavelength of the amplitude modulation in such a manner that the distances which occur in practice are indeed uniquely determined.

Preferably, a wavelength of the modulation, for example amplitude modulation, of the emitted radiation is between 1 mm and 5 metres. With such a wavelength it is possible to determine unambiguously distances up to a maximum distance of 0.5 mm to 2.5 metres. Associated therewith is a modulation frequency of 300 MHz to 60 kHz which can be achieved in a simple manner in electric circuits for actuating LEDs. It is pointed out that, if desired, it is also possible to choose even smaller or greater wavelengths.

The above-described object is additionally achieved by a method according to the instant invention comprising emitting modulated electromagnetic radiation, in particular light, in the direction of at least one of the animals, receiving, by means of a matrix with a plurality of rows and a plurality of columns of receivers, electromagnetic radiation which has been reflected by at least one part of the at least one animal, determining, for each of the receivers, a phase difference between the emitted and the reflected electromagnetic radiation, calculating a depth-image of the at least one part of the at least one animal, comparing information regarding the observed depth-image with reference information regarding the animal, and generating control information on the basis of this comparison.

The invention also relates to a computer arranged to perform the aforementioned method steps and to a software program comprising program instructions for arranging the computer to perform the aforementioned steps.

### BRIEF DESCRIPTION OF THE DRAWINGS

The features and advantages of the invention will be appreciated upon reference to the following drawings, in which:

FIG. 1 is a perspective view of one embodiment of the invention showing a method and system for managing animals;

FIG. 2 is a perspective diagrammic view of a camera in a system for managing animals; and

FIG. 3 is a diagrammatic view of a system for managing animals.

### DESCRIPTION OF ILLUSTRATIVE EMBODIMENTS

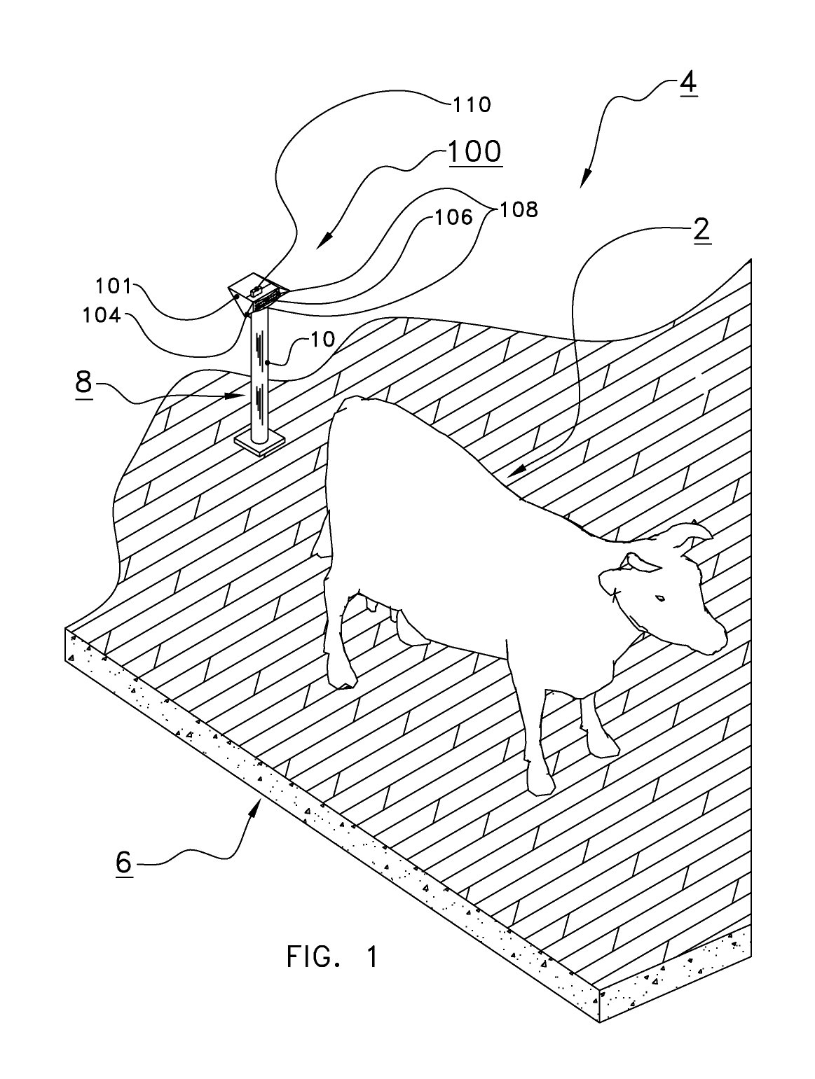

The following is a description of certain embodiments of the invention, given by way of example only and with reference to the drawings. Referring to FIG. 1, a diagrammatic view of an animal, in this example a cow is shown and denoted by reference numeral 2. The cow 2 is located in an accommodation 4, such as a shed or a pasture, having a ground 6. There is provided a support 8 in the accommodation 4. In this case, the support 8 comprises a post 10, which is provided on the ground 6, and a ball joint (not shown).

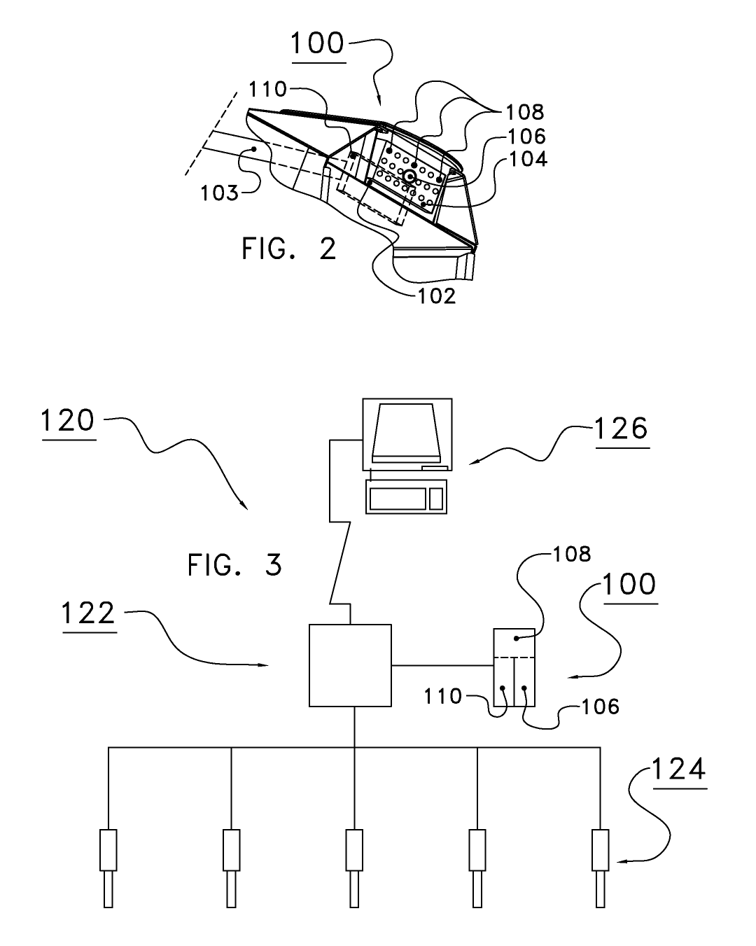

On the ball joint there is provided a camera, in this case a combined 2D/3D camera 100. The 2D/3D camera 100 comprises a housing 101 of synthetic material (see FIG. 2). The 2D/3D camera 100 is capable of rotating about a vertical axis by means of the ball joint and of tilting about a horizontal axis by means of the ball joint with the aid of actuators (not shown in FIG. 1), for example servo motors. These actuators are explained in further detail with reference to FIG. 3.

Alternatively, the 2D/3D camera 100 may be fixedly connected to an existing construction, such as a fence around the pasture, a wall of the shed, or a frame of a milking machine. The 2D/3D camera 100 is preferably provided at a position where animals walk past a plurality of times per day, such as at a feeding place, or at a milking place, or at an entrance to such places. It may be connected to the stationary world by means of a hinge which substantially allows a pivoting movement about a vertical axis, and be connected by a hinge without actuators. However, the support may also be provided on a vehicle, in particular an unmanned vehicle, and move along with this vehicle between or above the animals to be observed.

The housing 101 comprises a front side 104 (FIG. 2). In the front side 104 there are included a lens 106 and a plurality of radiation sources, in this embodiment light sources 108 in the form of infrared light emitting diodes (IR LEDs). In a variant, the lens 106 is provided on the inside of the front side 104, the front side 104 being made of a material which is transmissive of infrared light. In this manner, the lens 106 is protected from external influences and the flat plastic front side 104 can be cleaned more easily than the front side 104 having a protruding lens 106.

In the housing 101 there is further included a place-sensitive sensor, such as a CMOS image sensor 110. The CMOS image sensor 110 comprises, on a side facing the lens 106, a matrix with a plurality of rows and columns of receivers, in the form of light-sensitive photo diodes. In this exemplary embodiment, this is a matrix of 64×64 photodiodes, but resolutions of 176×144, 640×480, and other, smaller or greater, matrices are likewise possible. The CMOS image sensor 110 comprises integrated sensor controller which drive the IR LEDs 108 and which process the infrared light which impinges on each of the photodiodes to form a digital signal and pass this onto a central processing unit or computer via a wireless (not shown) or wire connection (see further below).

The sensor controller of the 2D/3D camera 100 determine the distance of an object relative to each of the photodiodes by means of measuring a phase difference between the light which is emitted by the IR LEDs 108 from the 2D/3D camera 100 to an object and the light which returns, after having been reflected, to the 2D/3D camera 100, i.e. to the CMOS image sensor 110 thereof.

In another embodiment, the IR LEDs 108 emit an amplitude-modulated wave light signal. The amplitude modulation itself has a repetition frequency. After reflection this light signal is imaged by the lens 106 on the CMOS image sensor 110. By determining the phase difference of the received modulated light signal relative to the emitted modulated light signal it is possible to calculate, by means of the wavelength of the modulated signal, the distance between the sensor and the object. This occurs in parallel for each of the photo diodes on the CMOS image sensor 110. There is thus created a spatial or depth-image of the observed object.

It should be noted that the distance has not yet been uniquely determined in this manner. After all, an object may be at a distance from the sensor which is a multiple of wavelengths of the light signal used. In practice, this can be solved, for example, by varying the frequency of the amplitude modulation as well.

In a particular embodiment, short light pulses may be emitted by the IR LEDs 108, provided each light pulse comprises at least one whole wave, preferably two or a plurality of waves, of the modulated signal.

Depending on the selected frequency of the amplitude modulation, the 2D/3D camera 100 can take a plurality of, for example fifty, images per second. Each image is in this case to be regarded as a reliable reproduction of the observed cow 2.

In addition to a spatial image, the CMOS image sensor 110 in this exemplary embodiment can also generate a 2-dimensional image, in which differences in colour and reflection of the observed object are converted into different shades of grey.

FIG. 3 is a diagrammatic view of a system 120 which is arranged to manage a group of animals. The system 120 comprises a control system, here in the form of a central processing unit 122. The central processing unit 122 is operatively connected to the 2D/3D camera 100, and to the animal management or actuator mechanism, among which one or a plurality of actuators 124 and a user station in the form of a personal computer (PC) 126. Incidentally, the PC 126 also serves as an inputting means and as a storage means, but these three functions need not be combined in one apparatus. In this embodiment wire connections are shown, but one or a plurality of components may, of course, also be connected via wireless connections.

The actuators 124 comprise the servomotors not shown in FIG. 1 for directing the 2D/3D camera 100 itself. Optionally, there may also be provided actuators for opening animal guiding mechanism (not shown), such as automatically operable fencings and animal driving means. The central processing unit 122 is arranged to perform various tasks, which are to be described in more detail below. To this end, the central processing unit 122 in this exemplary embodiment has a working memory and is programmed using control software and interprets the images of the 2D/3D camera 100 on the basis of algorithms, and/or fuzzy logic control. Based on this interpretation, the central processing unit 122 generates control information, which may be displayed on a monitor or printer of the PC 126 and which may be processed further by the central processing unit 122 itself, by the PC 126, or by another not shown computer. It is also possible for the central processing unit 122 to control said one or a plurality of actuators 124 with the aid of control information.

The PC 126 is preferably provided with, or connected to, further peripheral equipment, such as a storage medium (not shown), on which images from the camera and/or control information can be stored. The PC 126 may be the same PC which is also used to perform other tasks of, for example, a dairy farm. The PC 126 may also form part of a network of computers which together, for example, carry out various processes on the dairy farm, such as farm management and controlling and monitoring robots, such as milking robots, robots for making available grassland in a metered manner and robots for removing dung.

In use, the 2D/3D camera 100 will form a depth-image of at least one part of an animal, such as a cow. This image may be processed digitally in various manners by the central processing unit 122 into information regarding the observed depth-image and be compared with reference values. In particular, the processing results in a set of coordinates of the shape of the observed part. This set may reproduce the entire shape, or only a few characterizing aspects thereof. In a variant there are deduced from the observed depth-image one or a plurality of indicators which are representative of a particular aspect of the observed shape, such as a convex surface, concave surface, contents, or irregularity. In particular, the reference values relate to a reference shape of the relevant part of the animal, or reference values for one or a plurality of characterizing aspects. A detailed example of processing and comparing images is described in EP-A1-1,537,531, which is hereby incorporated by reference. However, other algorithms are also possible.

In a first application, a part to be observed of an animal comprises a left side of a cow 2 and the 2D/3D camera 100 is provided obliquely to the left behind the cow. The 2D/3D camera 100 forms a depth-image of the left side, on the basis of which the central processing unit 122 determines a score which is representative of a contents of the paunch. On the basis of the score for the paunch contents of the cow in question, the central processing unit 122 subsequently generates control information which is related to the feed intake of the cow in question on the relevant day. At a low score, which means that the cow has eaten little to nothing, the control information comprises a signal for a user that the cow in question should be separated because of possible illness, is not allowed to have access to feed, and/or is on heat. By combining the score with signals from other sensors, it is possible for the central processing unit 122 to indicate which is the most probable cause. Control information for the purpose of separation is preferably also led to an actuator 124 for operating an animal guide means, such as an automatic fencing, and/or a drive means.

At higher scores for the paunch contents, the central processing unit 122 compares the paunch score with a desired score for the lactation period of the cow in question. If the observed score and the desired score do not correspond, the control information comprises information regarding the adaptation of an individual feed diet of the cow. Such control information may be displayed via the PC 126, and/or be sent directly as a control signal to an automatic feeding device. Besides an analysis of the contents of the paunch, the central processing unit 122 may also analyse an activity of the paunch, in particular the frequency of this activity, on the basis of successive depth-images.

By means of a plurality of scores for the paunch contents of a plurality of cows, the central processing unit 122 generates meta-control information. This meta-information comprises information regarding the degree to which the cows in question are well-fed and, possibly, collective adaptations of the feed diet.

In a second application, the 2D/3D camera 100 generates, from a position substantially straight behind a cow 2, a depth-image of the rear side of the cow. Within this depth-image, it is possible for the central processing unit 122 to recognize the buttocks of the cow 2. It is further possible for the central processing unit 122 to analyse whether the depth-image also shows a part of the abdomen of the cow 2 on either side of the buttocks. If this is not the case, not only the paunch but also the intestines are empty. This is an indication that the cow has eaten too little feed, or feed of insufficient quality, during a plurality of days. The central processing unit 122 generates control information, which is displayed on the PC 126, that the cow in question should be examined further. Control information for the purpose of a separation action may also be led to an actuator 124 for operating an automatic fencing and/or a drive means.

In a preferred variant, the analysis of the abdomen is combined with other observations of the 2D/3D camera 100, from which the behaviour of the cow in question around a feeding place is preferably analysed. In that case, the control information comprises an indication of whether a low feed intake may be a consequence of anxious behaviour of the cow. As described above in relation to the paunch contents, the analysis of the abdomen may also be combined with information from other sensors and the central processing unit 122 may generate meta-control information if there are a plurality of cows having a too empty abdomen.

In a third application, there is determined a condition score by means of a depth-image which is taken by the 2D/3D camera 100 straight from behind and/or obliquely from behind. From this depth-image, these depth-images, respectively, the shape of the skin around the lumbar vertebrae and/or around the croup of the cow is analysed. It is possible to analyse the spinous processes and/or the transverse processes of the lumbar vertebrae. Around the croup it is possible to analyse the seat bones and the cavity below the tail. The more clearly the lumbar vertebrae and/or the seat bones are visible relative to their environment, the lower the condition score. The less clearly the lumbar vertebrae and/or the seat bones are visible and the more the cavity below the tail is filled, the higher the condition score.

It is possible for the central processing unit 122 to combine the condition score with the information regarding the paunch contents and/or the abdomen. Preferably, the central processing unit 122 will combine the individual condition score with information regarding the lactation cycle of the cow. If the condition score does not correspond to a score which is desired for the relevant phase of the lactation cycle, the central processing unit 122 will generate control information that the cow in question should be examined further, should have an adapted individual feed diet, and/or that the cow should be separated.

The central processing unit 122 may further generate meta-control information by means of the condition score of a plurality of cows. An average of the condition score which deviates from a desired value provides control information regarding an adaptation of the composition of the feed. A high spread in the condition score of the plurality of cows results in a control information that the group behaviour should be analysed further, preferably by the central processing unit 122 itself on the basis of images of the 2D/3D camera which show a plurality of animals simultaneously.

In a fourth application, the central processing unit 122 generates control information regarding the layout of an accommodation of the animals, in particular of a cowshed. Such control information is in particular generated if the same deviation of a cow results from the depth-images of a plurality of cows. A plurality of depth-images which show a lump on a shoulder indicate, for example, an incorrect design of the feeding gate. Swellings on a foreknee indicate a too hard box floor. Walking with legs wide apart indicates a too slippery floor. It is possible for the central processing unit 122 to generate control information to the PC 126 which advises the user, if necessary, to analyse further and, preferably, to adapt a relevant component of the accommodation.

In a fifth application, the central processing unit 122 generates control information regarding the health of an animal and/or of a group of animals. For this purpose, the analysis of paunch, abdomen, and/or condition may be used, as described above. Instead of or in addition to this, there may be formed a depth-image of other parts of the animal and of the whole animal, and be compared with a desired shape, in order to trace deviations which may be connected with an illness. Examples thereof are a deviating attitude during lying, standing and walking, a deviating position of the ears, and a lump at the place of the abomasum. By taking depth-images in relatively quick succession, preferably a plurality of depth-images per second, it is possible for the central processing unit 122 to analyse the respiration and to compare it with the respiration of a healthy animal. It should be noted that information which is only based on one or a plurality of depth-images is insufficient for diagnosing an illness. In particular, the invention does not relate to diagnosing an illness, but does relate to providing an indication that an animal may be ill. Relevant control information may be in the form of a list of animals to be examined on the PC 126, an automatic reporting to a veterinary surgeon, and/or a signal to one or a plurality of actuators 124 for separating an animal.

In a sixth application, the control information is related to an expected calving moment of a cow. By forming and analysing a depth-image of the pelvis ligaments (visible next to the tail), the vagina and/or the udder, it is possible to forecast whether a cow will calve within 24 hours. The relevant control information comprises a signal which is used to separate the cow in question, either by human intervention via a message on the PC 126, or by operating actuators 124 of fencings and/or drive means. Moreover, the control information may comprise a signal that the cow in question should be milked, in order to reduce the tension on the udder before calving.

In particular, the invention also relates to generating control information regarding the milking of the animals. In a preferred variant, however, the invention relates to generating control information for managing a group of animals, with the exception of control information regarding the milking of animals. By control information regarding the milking is meant information for opening a fencing of a milking parlour, controlling a robot for connecting and disconnecting teat cups and controlling a robot for cleaning teats and/or the whole udder. Such control information may be generated by the central processing unit 122 on the basis of analysing one or a plurality of depth-images in order to determine the identity of a dairy animal which reports at a milking machine, the presence and the exact position of a dairy animal at and relative to the milking machine, respectively, the position, shape and size of the udder and the teats immediately preceding the connection of a milk cluster, position, shape and size information of the teats and the hind legs during the cleaning of the udder and/or the teats, during the connection and disconnection of a milk cluster and during the time the milk cluster is in its connected position, the position of the legs and the back of the dairy animal during the milking, and a mutual position and movement between the teats and the teat cups.

Various variants are possible without departing from the scope of the invention. The central processing unit may comprise a programmable unit, but may, for example, also be composed of non-programmable logic circuits and/or of memories which can only be programmed to a limited extent, such as an (E)EPROM. The control system is arranged to perform the above-described tasks. A customary method of arranging a control unit is by programming it by means of software. Alternatively, or in combination with specific software, the control unit may also be completely or partly composed of electronic components comprising previously provided circuits for carrying out (part of) the described tasks. In other words, the control unit can be equipped to carry out its tasks by means of software and/or specific hardware.

Instead of a combined 2D/3D camera, a 3D camera without 2D functionality may also be used. Instead of one 2D/3D camera, a plurality of 2D/3D cameras may also be provided.

It is also possible for at least one animal, some of the animals or all of the animals to be provided with a GPS receiver and a transmitter for transmitting the current situation of the animals in question. Furthermore, the system may be provided with a feed dispensing sensor for observing the dispensing of solid and/or liquid feed to an animal, also including water. It is thus possible for the system to generate the control information also on the basis of an amount and/or composition of the dispensed feed.

The animals may also be provided with a feeding sensor which, in combination with the position information, also makes it possible to determine whether or not the animal in question is feeding or not. The system may also be connected to milk sensors which measure the quality of milk yielded. Thus, the invention has been described by reference to certain embodiments discussed above.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A system arranged to manage a group of animals, comprising:
a control system,
a camera, operatively connected to the control system, for forming a depth-image of at least one of the animals, and
an animal management or actuator mechanism operatively connected to the control system, wherein the control system:
compares information regarding the depth-image formed by the camera with reference information regarding the animal,
generates control information on the basis of this comparison, and
sends the control information to the animal management or actuator mechanism, and
wherein the camera comprises:
a source of radiation for emitting electromagnetic radiation,
a matrix with a plurality of rows and a plurality of columns of receivers for receiving electromagnetic radiation reflected from the dairy animal,
a lens for displaying the reflected electromagnetic radiation on the receivers, and
a sensor controller operatively connected to the source of radiation in order to modulate the electromagnetic radiation and for determining for each of the receivers a phase difference between the emitted and the reflected electromagnetic radiation.

2. The system according to claim 1, wherein the animals comprises dairy animals.

3. The system according to claim 1, wherein the electromagnetic radiation comprises light.

4. The system according to claim 1, wherein the animal management or actuator mechanism comprises actuators.

5. The system according to claim 4, wherein the actuators are operatively connected to an animal guiding mechanism.

6. A method of managing a group of animals, comprising:
emitting modulated electromagnetic radiation in the direction of at least one of the animals,
receiving, by a matrix with a plurality of rows and columns of receivers, electromagnetic radiation which has been reflected by at least one part of at least one animal from the group of animals,
determining, for each of the receivers, a phase difference between the emitted and the reflected electromagnetic radiation,
calculating a depth-image of the at least one part of the at least one animal,
comparing information regarding the observed depth-image with reference information regarding the animal,
generating control information on the basis of this comparison.

7. The method according to claim 6, wherein the electromagnetic radiation comprises light.

8. The method according to claim 6, wherein the group of animals comprises dairy animals.

9. The method according to claim 6, followed by a step of generating meta-information regarding a plurality of animals, by analysing the control information of the animal.

10. The method according to claim 9, wherein the meta-information comprises a list of animals which should be treated separately from other animals in the group of animals.

11. The method according to claim 6, wherein the control information comprises information regarding the separation of at least one animal from the group of animals.

12. The method according to claim 6, wherein the control information relates to information regarding the layout of an accommodation for the at least one animal.

13. The method according to claim 6, wherein the control information relates to information regarding the feeding of one or a plurality of animals.

14. The method according claim 6, wherein the control information relates to information regarding an indication of the health of the at least one animal.

15. The method according claim 6, wherein the electromagnetic radiation is emitted to, and received from, a plurality of animals.

16. A system comprising a computer and the matrix according to claim 6, wherein the computer is programmed to perform the steps of determining the phase difference, calculating the depth-image, comparing the information regarding the observed depth-image with reference information regarding the animal, and generating the control information on the basis of this comparison.

17. Computer readable medium comprising program instructions for programming the computer according to claim 16.
